(19) United States
(12) Patent Application Publication
(10) Pub. No.: US 2008/0304150 A1
(43) Pub. Date: Dec. 11, 2008

(54) Screen and projection system using the same

(76) Inventor: Naofumi Yamauchi, Kashiwa-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/072,627

(22) Filed: Feb. 27, 2008

(30) Foreign Application Priority Data
Mar. 2, 2007 (JP) 2007-53278

(51) Int. Cl. G03B 21/60

(52) U.S. Cl. 359/459

(57) ABSTRACT

A front screen with a simple construction provides a wide viewing angle towards the desired direction, realization of an image projection system. The front screen that is utilized in present invention comprising a directional diffusing layer that transmits and diffuses incoming light from a specified angular range and linearly transmits incoming light from other angles, and a light-reflection layer that provides reflecting elements that scatters and reflects light. Furthermore, the light-scattering field of the reflecting elements in the light-reflecting layer in the up and down direction differs to that in the left and right direction and provides an anisotropic scattering property. Thereby, the construction is adjusted to the viewing condition.

### BACKGROUND OF THE INVENTION

1. Field of the Invention

The present invention is related to front screens, on which optical images from high brightness CRT or LCD projectors are displayed as well as a to projection systems utilizing aforementioned screen.

2. Description of the Related Art

Optical image projection systems that utilizes high brightness CRT or LCD projection systems found various applications because of large images with high resolution can be displayed simply and, therefore, can be applied as communication tools for a large number of users.

In recent times, the need for screens that provide a good visible image under bright conditions has emerged.

To minimize the effect of ambient light for the observer, embodiments are known that utilize directional diffusing sheets that transmits and diffuses incoming light from a specific angular range and linearly transmits incoming light from other directions, together with a prism sheet with saw-blade like profiles and ridges in the horizontal direction, in which the prism sheet provides angles of elevation that are inclined towards the external light and the surface of the prism sheet having a light-reflecting layer (for example refer to patent literature 1)

Another embodiment is known (for example refer to patent literature 2) for the purpose of providing effectively displayed images towards a plurality of observers to the left and right side, in which structures with a directional reflection properties are provided on the surface of the screen such as lenticular lenses, in which the incoming light ray that enters a pixel is guided in an appropriate path so that it is widened to the left and right direction by the means of a reflecting surface on the rear side of the screen that has the structure of a vertically oriented linear fresnel lens.

Patent literature 1: JP-A2005-300907 (FIG. 3)
Patent literature 2: JP-A2002-311507

### SUMMARY OF THE INVENTION

However, front screens utilizing directional diffusing sheets according to the patent literature 1 could not achieve both: widening the viewing angle range to the left and right direction as well as cutting off light from the illumination.

Also, screens according to patent literature 2 cannot be widely utilized and the requirement of the application of lenticular lenses to correspond the pixel is cost driving. Furthermore, the increase of the viewing angle is limited due to the light-absorbing layer, that is also absorbing utilized light so that the light efficiency is bad and results in darkening.

The projection system of the present invention comprises a screen that is displaying an optical image, and an image projector that projects the optical image to the screen, in which the screen has the structure as the followings. This screen comprising a directional diffusing layer that transmits and diffuses incoming light from a specified angular range and linearly transmits incoming light from other angles and a light-reflection layer on the other side of the directional diffusing layer in regard of the projection, in which the light reflection layer comprising scattering elements that reflect and scatter light anisotropically so that the light-scattering field in the up and down direction differs to that in the left and right direction. Thereby, a wide viewing angle in the most desirable direction can be obtained that matches well with the observation condition.

Also, a light-reflection layer is utilized that has the property to scatter light in a wider range in left and right direction of the screen compared to the up and down direction. Thereby, a wide viewing angle in the left and right direction can be obtained and a plurality of observers can view the image.

The light-reflection layer may have structures such as grooves, protrusions, ellipses, continuous grooves or continuous protrusions. Furthermore, Moire effects due to the interference with the pixel pitch can be suppressed by positioning the grooves or protrusions randomly on the light-reflection layer.

Also, reflecting particles that have anisotropic shapes may be utilized as reflection elements and are positioned on top of the light-reflection layer. This provides the anisotropic scattering property to the screen, in which the angular range of scattering differs in the up and down direction to that in the left and right direction. In practice, it is sufficient if the structure posses a long and a short axis such as rod like or elliptic shapes (like a rugby ball). The reflecting particles may be made of light reflecting material such as metals or be made of glass or resin that is coated on the surface with light-reflecting materials such as metals. The angular range of scattering in the left and right direction can be widened by the alignment of the long axis of such light-reflecting particles towards the up and down direction. The field of scattering is widened in the up and down direction if the long axes are oriented in the left and right direction. Any property in the scattering field can be obtained by mixing light-reflecting particles with various orientations.

It is also possible that various different types of reflecting elements that have different anisotropic light-scattering properties are mixed. Through such means, the setting of the range of the reflection angle of the screen can be freely controlled. In the case of multiple types of reflector elements, one group of the reflecting elements has a different scattering property compared to the second group of reflecting elements. In the case that reflecting elements of the group-1 and group-2 have the same principal shape then their orientation angles in the light-reflecting layer differ within these two groups.

According to the present invention, a front screen and an image projection system can be realized that can provide a wide viewing angle and that is optimized to the observation condition.

### BRIEF DESCRIPTION OF THE DRAWINGS

In the accompanying drawings:

FIG. 1 is a construction scheme that shows an image projection system according to present invention;

FIGS. 2A to 2C are each a FIG. that describes the anisotropic scattering property.

FIGS. 3A to 3C are each a construction scheme that shows a directional diffusing layer that is utilized in the present invention.

FIGS. 4A and 4B are each a FIG. that schematically shows examples of ray paths within a screen of present invention.

FIG. 5 is planar view of a construction model of the light-reflecting layer.

FIGS. 6A to 6E are each cross-sectional view of a part of the construction model of the light-reflecting layer.

FIG. 7 is planar view of a construction model of the light-reflecting layer.

FIGS. 8A to 8C are each cross-sectional view of a construction model of the light-reflecting layer.

FIG. 9 is planar view of a part of the construction model of the light-reflecting layer.

FIG. 10 is planar view of a part of the construction model of the light-reflecting layer.

### DETAILED DESCRIPTION OF THE PREFERRED EMBODIMENTS

### Embodiment of Image Projection System

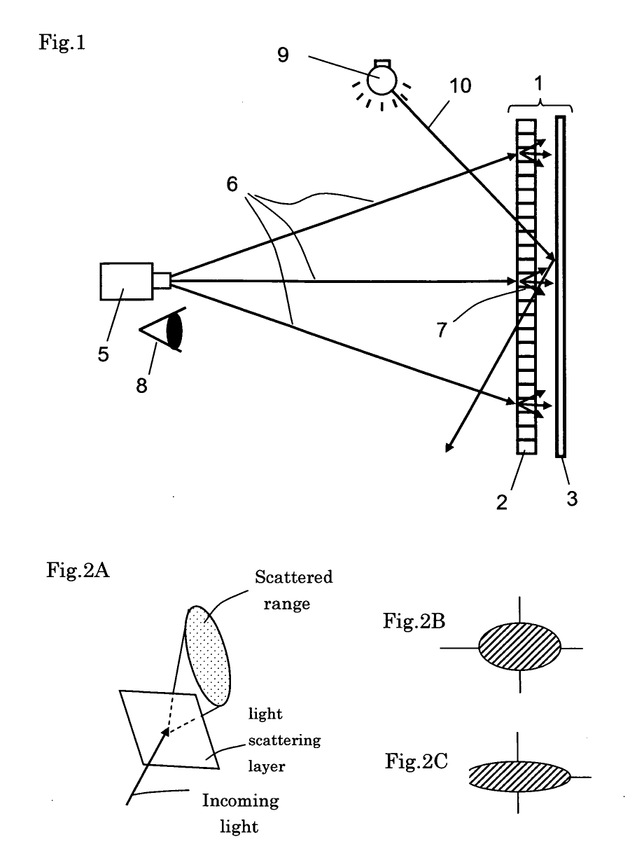

The image projection system according to present invention is explained with FIGS. In FIG. 1, an image projection system according to present invention is shown. The image from the optical image projection unit 5 is projected on the screen 1 within a certain angular range around the central axis.

The screen 1 is comprising a directional diffusing layer 2 that transmits and diffuses incoming light from a specific angular range and linearly transmits light from other directions and a light-reflecting layer 3 that is provided on the rear side of the directional diffusing layer and, therefore, is provided on the other side of the screen in regard to the projection side. The light-reflecting layer does not only reflect the incoming light but has also anisotropic reflection and scattering properties in regard of the scattering field. The viewing field in regard to a specific direction can be widened through such a construction.

Therefore, the viewing angle can be controlled by the modification of the anisotropic scattering field of the light-reflecting layer 3. In such instance, the directional diffusing layer 2 is set up such that the projected beam 6 from the projector 5 lies within the aforementioned specific angular range and the light from the illumination 9 or ambient light 10 lie outside the aforementioned specific angular range.

A case in now explained, in which the right reflecting layer 3 has a wider scattering field in the left and right direction than in up and direction. The projected beam 6 is transmitted and scattered whereas light from the illumination or ambient light is linearly transmitted through the means of the directional diffusing layer 2. Then, light 7 that is transmitted and scattered through the directional diffusing layer 2 is further scattered and reflected through the light-reflecting layer 3. Thereby, the transmitted and scattered projection beam is scattered and reflected in a wide range to the left and right direction. Note that the scattered and reflected light rays are not visualized in FIG. 1. This scattered and reflected light is re-entering the directional diffusing layer 2 and, depending of the incoming angle, it is further diffused during transmittance. As a result, the projected beam reaches a wide range in the left and right direction because it is widely scattered and reflected to the side of the viewing position 8. This enables that the observer from the viewing position 8 can see a displayed image within a wide viewing angle. This means that an array of observers can simultaneously see the displayed image.

According to present invention, the field of view can be widened in any desirable direction by the provision of anisotropic properties to the light-reflecting layer and it is not necessary that the directional diffusing layer provides anisotropic character towards the up and down direction compared to the left and right direction. It is relatively simple and inexpensive to manufacture a light-reflecting layer with anisotropic properties. This means, one has to form reflecting elements for the light-reflecting layer that provide the anisotropic property in light scattering and reflection in vertical versus horizontal direction. According to the present invention, the viewing angle of a front screen with a directional diffusing layer can be widened in any direction by the means of a simple and inexpensive construction.

Now, the scattering and diffusing property of the light-reflecting layer is explained. In FIG. 2, a case is schematically visualized, in which the incoming light is scattered anisotropically. Thereby, only a transmitting and not a reflecting case is visualized. As shown in FIG. 2A, the incoming light that enters the light transmitting and scattering layer is scattered within a certain range. The field, in which the scattered light reaches is indicated in the center of the FIG. as field of light scattering and the more elliptic the field is the stronger is the anisotropy. Examples of such scattering properties are provided in FIG. 2B and FIG. 2C. In both cases of FIG. 2B and FIG. 2C, the field of light scattering is larger in the left and right direction (horizontal direction) than in the up and down direction (vertical direction). Therefore, a large amount of light is directed towards the left and right direction. The anisotropy is larger for the case in FIG. 2C than in FIG. 2B. A screen with a large viewing field on the left and right direction can be realized by the utilization of a scattering and reflecting layer with such an anisotropic character as a light-reflecting layer.

As exemplified in FIG. 2, a light-scattering layer is described, in which the field of light scattering is the largest in the left and right direction. However, the direction with the largest field of scattering can be freely set up by the modification of the shape and layout of the reflecting elements. Furthermore, reflecting elements of various types that have different anisotropic scattering properties may be mixed and utilized for the light-reflecting layer. Thereby, it is possible to design a peak in the field of scattering not only in one direction but in a variety of directions and a free control of the range of the reflection angles is possible.

In the case, in which ambient light is incoming with an incident angle from above, disturbing reflection can be avoided by the right setup of the specific angular range of the directional diffusing layer and the scattered reflection property of the light-reflecting layer. This means that through a suitable setup of the specific angular range of the directional diffusing layer and of the scattered reflection property of the light-reflecting layer the required light can be guided to a wide angular range, whereas non-required light does not disturb.

### Embodiment of Screen

A directional diffusing layer is placed on the projector side and a light-reflecting layer with an anisotropic scattering and reflection property is positioned behind the directional diffusing layer in a screen according to present invention and as shown in FIG. 1. Such a light-reflecting layer may be realized by the provision of light reflecting elements that scatter and reflect light that enters the light-reflecting layer. This means that even if the light-reflecting layer itself does not provide scattering properties, an anisotropic scattering and reflection property of the light-reflecting layer can be realized by the formation of light-reflecting elements that have itself anisotropic scattering and reflection properties in respect of the scattering field. A case is explained here, in which the light-reflecting elements scatter light in a wider range towards the left and right (horizontal) direction than towards the up and down (vertical) direction.

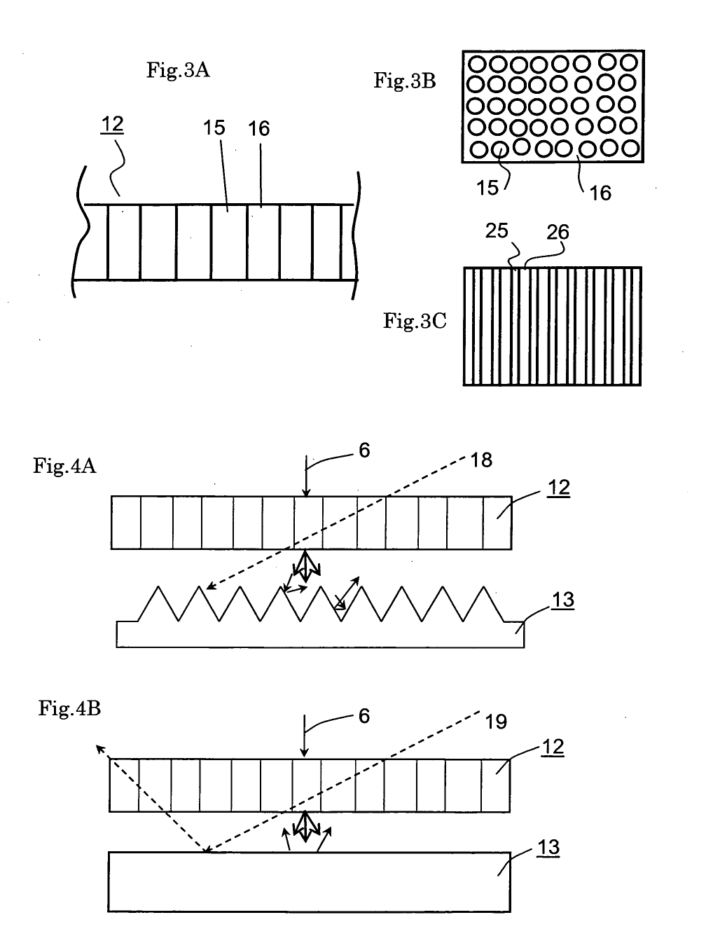

On the other side, the directional diffusing layer has the property of transmitting and diffusing light incoming from a specific angular range and linearly transmits incoming light from other directions. As example for such a directional diffusing layer, light-diffusing sheets with below mentioned structures may be given. In FIG. 3A, FIG. 3B a sheet 12 with column-shaped lens structures is given as example for a light-diffusing sheet. The construction of a sheet with column-shaped lens structures is schematically shown in FIG. 3A as a cross section model and in FIG. 3B from top view. Such column-shaped lens sheet 12 is comprising a plurality of fine column-shaped structures 15 that are arranged within the area and in which the center region of the column-shaped structures has a higher refractive index than the surrounding outer region and the column-shaped structures have the property of guiding light in the thickness direction of the sheet. Therefore, such column-shaped structures 15 (high refractive index region) provide some type of columnar lenses, whereas a plurality of these columnar lenses are arranged within the area of the column-shaped lens sheet (matrix with low refractive index).

In the described case, the column-shaped lenses have a circular cross section in regard of the surface, however, structures with a variety of other cross section may be utilized such as those with symmetric square or hexagonal cross sections or structures with anisotropic and longitudinal cross sections such as ellipses or rectangles as well as irregular structures with irregular boundaries. Therefore, the column-shaped lens sheet has the structure of a plurality of columnar shaped graded-refractive index lenses or step-index lenses that are arranged within the area. The column-shaped graded-refractive index lenses have a structure, in which the refractive index increases towards the center and there is no sharp boundary between the regions with high and low refractive indexes. In turn, the column-shaped step-index lenses have a dual structure, in which the refractive index of the center region is higher than the surrounding outer region.

Here, we call the direction of the axes of the column-shaped lenses the alignment direction. The alignment direction of the column-shaped lenses of the column-shaped lens sheet 12 coincides more or less with that of the projection direction (the center axis of the projected beam). In such a setup, the projected beam that has a certain angular distribution can be positioned with a good balance fully into the area, in which incoming light scatters during transmission. In the case where the distance between projector and screen varies, the probability is high that the projected beam enters into the light-diffusing sheet within the angular range, in which the light is scattered during transmission.

Another type of directional diffusing layer is known, in which the layer has a layer-shaped lens structure and light is guided in the thickness direction. The structure of such a directional diffusing layer is schematically shown in FIG. 3C from a top view. The layer-shaped lens layer has a layer structure, in which the first region 26 with a lower refractive index is spread out continuously in the thickness direction and is alternating with a second region 25 that is also spread out continuously in the thickness direction and has a higher refractive index than the first region. The alignment direction of these layer structures coincides more or less with the axis of the projection beam.

Next, the path of the light beam that enters a screen according to present invention is explained for the case, in which the above mentioned column-shaped lens sheet 12 is applied as the directional diffusing layer. The light-reflecting layer is positioned behind the directional diffusing layer that is a column-shaped lens sheet 12 and, therefore, on the opposite side of the projected surface of the screen. The light-reflecting layer has the function to reflect and scatter the light and the scattering filed is anisotropic. The viewing angle can be widened in a specified direction through such a construction.

FIG. 4A shows a construction scheme of the screen as horizontal cross section and FIG. 4B shows a construction scheme of the screen as vertical cross section. In this case a reflection sheet 13 is utilized as light-reflecting layer and that has a surface structure of triangular protrusions as reflecting elements, in which the edges are continuously following the up and down direction.

According to the cross section of FIG. 4A, the projection beam enters into the column-shaped lens sheet 12 with a certain spread around the center beam axis. The column-shaped lens sheet has the function to transmit and scatter incident light from a specific angular range and linearly transmits light from other direction. We call the angular range, in which the incoming light is scattered and transmitted as specified angular range and the angle, in which the incoming light is linearly transmitted as the linear transmission angle. The column-shaped lens sheet is set up such that all the projection beams fall within the specified angular range and, therefore, the projected beams are widened through the column-shaped lens sheet 12 before reaching the reflection sheet. The reflection sheet 13 is provided with triangular grooves as reflection elements so that the surface of the two inclination planes actually reflects the scattered and transmitted light from the directional diffusing layer. These side planes have reflecting surfaces and, therefore, reflect light in a variety of angles in the horizontal direction depending on the incoming direction of the light. Therefore, scattering as well as reflection occurs.

Light from some incident angle is reflected more than once on the surfaces that are positioned on opposite sides before it is thrown back. Since the wavelength of the light is very small in comparison to the size of the reflecting elements and to their spatial distance the light is widely scattered in horizontal direction and nearly no scattering in vertical direction occurs. Therefore, the projected light can be viewed in a wide angle in horizontal direction. On the other hand, incoming light 18 from an angle, so that it is linearly transmitted is also scattered by the reflection sheet. However, the light intensity that reaches the observer is low. Especially, in a setup according to FIG. 1, in which the light from the indoor illumination enters in an angle of incidence from above the incoming light from the horizontal direction is weak and, thus, does not disturbing the observer.

According to the cross section in FIG. 4B, the path of the projected light 6 is principally same as already described with the help of the cross section of FIG. 4A.

This means that the projected beam enters the column-shaped lens sheet 12 within a certain spread around the center axis of the beam. The column-shaped lens sheet has the function to scatter and transmit incoming light from the specific angular range and linearly transmits light from other directions.

Since the column-shaped lens sheet is set up such that the projected beam fall all within the specific angular range the projected beam is diffused by the column-shaped lens sheet 12 and reaches the reflection sheet 13 as a widened beam.

The reflecting sheet 13 provides surfaces that scatters light to the left and right direction but does not provide reflecting surfaces in the up and down direction.

Therefore, scattering by the reflecting sheet 13 occurs selectively in the horizontal direction.

In a case, in which the light from the indoor illumination 19 enters with an inclination angle from above (see also FIG. 1) this irradiation has a larger tilting angle compared to the projection beam.

Therefore, the light from the illumination enters the column-shaped lens sheet 12 from the so called linear transmission angle and takes a similar path compared to the reflection by a standard mirror that is visualized in FIG. 4B.

Accordingly, the light from the illumination does not reach to the viewing point of the observer and a high contrast and a clear image can be provided without the disturbing effect of the light from the illumination.

In summary, a screen with the structure according to FIG. 4 has the property of widening the viewing angle in the left and right direction and remove illumination light from the up and down direction (so that it does not reach the observer).

In the followings, the light-reflecting layer that provides anisotropic light scattering and reflection properties and that are applicable for a screen of the present invention is explained with the help of FIGS.

The light-reflecting layer that is positioned behind the directional diffusing layer forms the screen. The following descriptive FIGS. are defined such that the up and down direction of the light-reflecting layer coincide with the up and down direction of the screen itself.

### First Embodiment of Light-Reflecting Layer

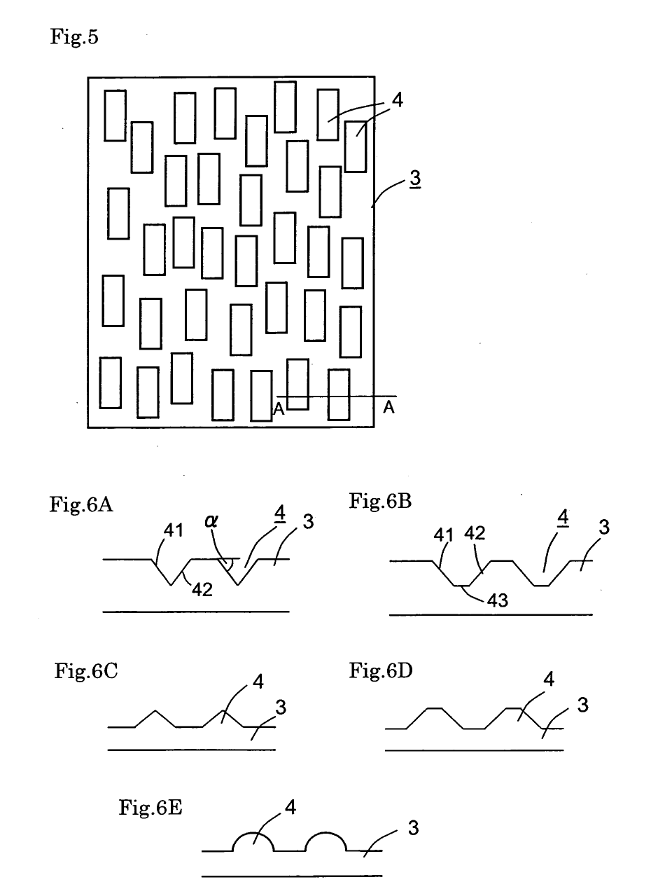

FIG. 5 provides a scheme of an example for the light-reflecting layer. According to the FIG., a plurality of light-reflecting elements 4 are randomly formed in the light-reflecting layer 3. In this case the reflecting elements 4 are positioned such that the scattering field in the left and right direction is wider than in the up and down direction.

The areas, in which light-reflecting elements 4 are formed scatters light, whereas areas, in which no reflecting elements 4 are formed simply reflect light.

This means that the anisotropy in the scattered reflection increases with the concentration of reflecting elements 4.

Additionally, Moire effects that are generated by the matching of the pitches of the projected image can be avoided since the reflecting elements 4 are positioned randomly.

Both, positive and negative relief structures may be utilizes as reflecting elements as long as a scattering and reflecting surface can be formed. In FIG. 6, cross sectional views according to the A-A line in FIG. 5 are given: inward V-shaped reflecting elements in FIG. 6A, inward trapezoid reflecting elements in FIG. 6B and structures with outward relief structures in FIGS. 6C to 6E.

FIG. 6C shows a case, in which the reflecting element has a triangular relief structure, FIG. 6D shows a case, in which the reflecting element has a trapezoid relief structure and in FIG. 6D a case is shown, in which the reflecting element have a semi-circular relief structure.

These reflecting elements are formed such that the valleys of the negative relief structures or the ridges of the positive relief structures are oriented parallel to the up and down direction so that the scattering field in the left and right direction is wider than in the up and down direction.

In other words, the inclined planes of the negative relief structures as well as the flanks of the positive relief structures are formed along the up and down direction.

In FIGS. 6A and 6B, the two inward planes 41, 42 that form the negative relief structure provide the light scattering and reflecting surfaces.

Since the light is reflected by the two inward planes 41, 42 to the horizontal direction, the scattering field in the horizontal direction is widened.

Therefore, the anisotropic property is realized since the light scattering and reflecting property in horizontal direction is large.

Thereby, the scattering power is increased by the increase of the angle α between the inclined plane and the flat surface plane as well as by the depth of the groove since the reflecting surface area is increased.

In the case of inward trapezoid as shown schematically in FIG. 6B, the bottom surface 43 provides an area of a regular mirror.

Therefore, the scattering power is decreased with the increase of the bottom surface area.

As described, the orientation and width of the scattering field can be freely designed by the appropriate adjustment of the proportion between scattered reflection an regular reflection that is realized by the shape and concentration of the reflecting elements.

In FIGS. 6C to 6E, the scattering and reflecting surfaces are formed by two flanks of the positive relief structures.

Also the case in FIG. 6E, in which the positive relief structures are semi-circular can be understood by the simplification of two flanks, in which their edges coincide with the peak of the circles.

Not only semi-circular structures may be utilized as reflecting elements for the reflecting layer, but also semi-cylindrical or elliptic positive relief structures as well as rod-like structures may be applied.

The situation of positive relief structures is very similar to the situation of the above described negative relief structures so that a detailed description is omitted here.

Thus, a screen with a wide viewing angle in the left and right direction can be realized by the application of reflecting elements 4 with such structures for the light-reflecting layer 3.

The reflecting elements 4 in FIG. 5 are visualized as rectangular shaped forms but may have other anisotropic shapes with a larger major axis and a shorter minor axis such as an ellipse.

In this case, the reflecting elements 4 have positive or negative relief structures similar to a rugby-ball shape.

For such structures, the direction of the scattering is position dependent. Thus, by the mixing of rectangular and elliptically shaped reflecting elements a variety of anisotropic properties of the scattered reflection can be designed.

A construction, in which the reflecting particles with a spherical elliptic shape are placed on top of the light-reflecting layer is possible.

### Second Embodiment of Light-Reflecting Layer

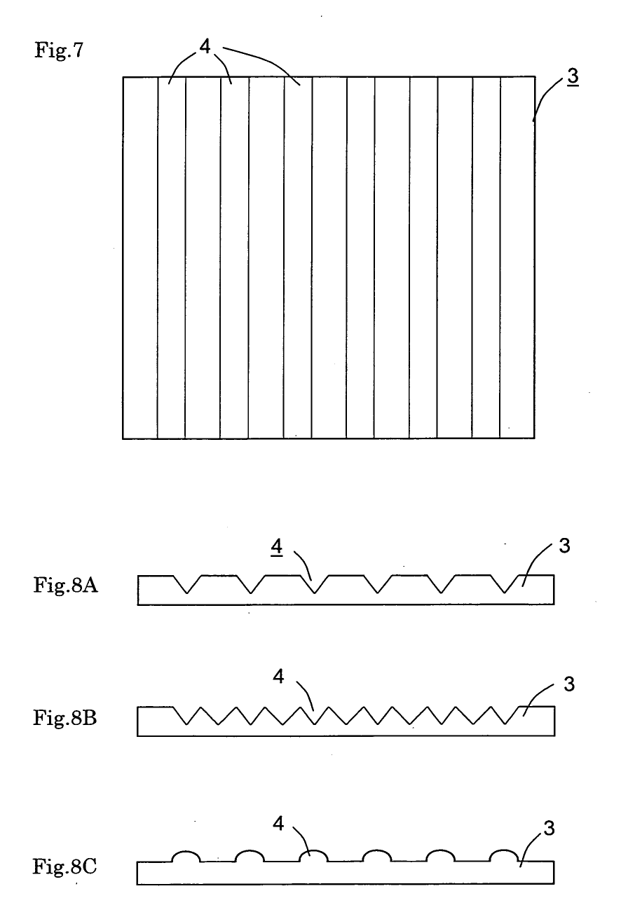

FIG. 7 shows a scheme of the present embodiment of a light-reflecting layer viewed from the side of the directional diffusing layer. As visualized, the reflecting elements 4 of the light-reflecting layer 3 are formed along the up and down direction. Thus, the reflecting elements 4 are continuously formed along the vertical direction of the light-reflecting layer. By the utilization of such reflecting elements, the same screen with a wide viewing angle in the left and right direction can be realized. FIG. 7 shows a construction, in which there is a spatial distance between the reflecting elements 4. Various other positive and negative relief structures can be utilized as reflecting elements 4 as long as a scattering and reflecting surface is formed.

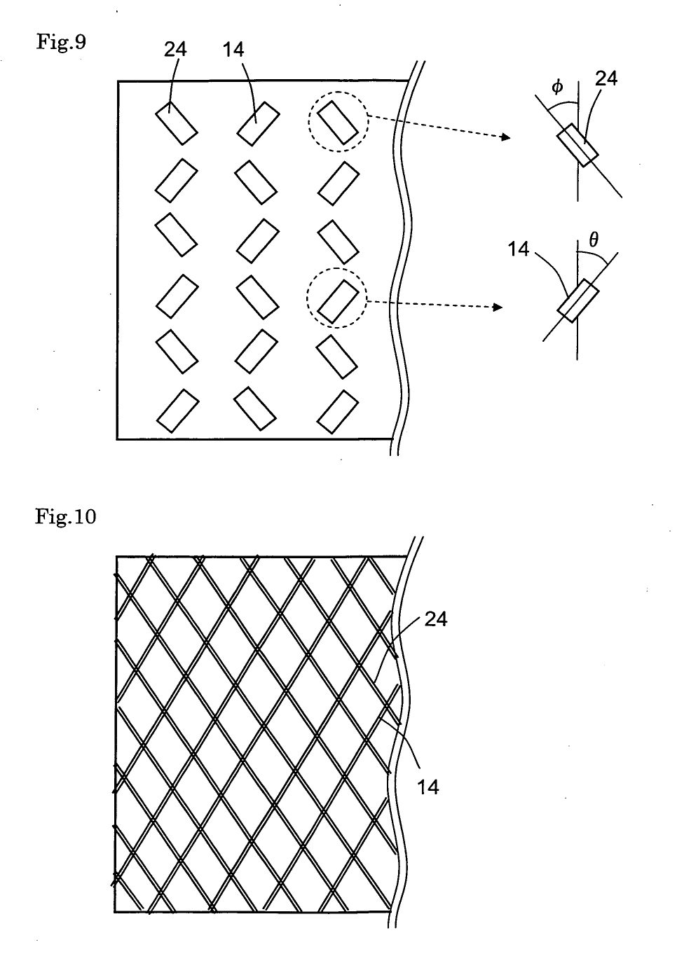

In FIG. 8, the cross-sectional view of the reflecting elements along the horizontal plane of FIG. 7 is shown. FIG. 8A shows a structure with inward V-shaped relief structure, in which there is a spatial distance given between the single reflecting elements. FIG. 8B shows a structure, in which the inward V-shaped relief structures are continuously arranged in the left and right direction so that the relief is similar to a saw-blade like profile. FIG. 8C shows a structure with elements with semi-cylindrical profile. As in embodiment 1, inward or outward trapezoid profiles may also be utilized.

The scattering power can be controlled by the variation of the depth (height) or the pitch of these positive or negative relief structures.

This means, that the scattering power increases with the depth as well as with the decrease of the spatial interval of the reflecting elements.

The effect of these reflecting elements of the present examples are principally same as those of example 1 so that a detailed description is omitted here.

### Third Embodiment of Light-Reflecting Layer

As described above, the range of reflection angle can be controlled by the structure and positioning pattern of the reflecting elements.

In the present examples, a consequent application for structuring of the above said is described.

A case is described in detail, in which the light-reflecting layer is constructed such that also a certain scattering occurs in the up and down direction.

This means, multiple types of reflecting elements with different scattering and reflection properties are utilized.

Thereby, a precise control of the proportion of scattered light in the up and down direction versus in the left and right direction is possible and the spatial range of the reflection angle of the screen can be freely designed.

In FIG. 9, a scheme is shown, in which multiples types of reflecting elements are formed on the light-reflecting layer, in which the scattering and reflection properties of the reflecting elements of type-I differ to that of reflecting elements of type-II.

As visualized, type-I of reflecting elements 14 have a clockwise tilting angle of θ towards the vertical axis, whereas type-II of reflecting elements 24 have an anti-clockwise tilting angle φ towards the vertical axis.

In contrast to example-1 and -2, in which the reflecting elements were oriented along to the vertical axis, the reflecting elements of this example have an inclination angle.

The type-I and type-II of reflecting elements have similar principal structures as of those in example-1 and differ only in the point whether there is or there is not a tilting angle towards the up and down axis of the screen. As described in example-1, the scattering power of these reflecting elements towards the plane along the orientation axis is low, whereas the reflecting and scattering power is high towards a plane that is perpendicular to the previous.

Thus, the reflecting elements 14 of type-I have the widest scattering and reflection field in a direction that is tilted by the angle θ relative to the left and right direction of the screen.

Consequently, the reflecting elements 24 of type-II have the widest scattering and reflection field in a direction that is tilted by an angle φ.

With such a construction, there is scattering not only in the left and right direction but also in the up and down direction.

The viewing angle can also be widened in the up and down direction.

Thereby, the proportion of scattering towards the up and down direction versus left and right direction can be controlled by the tilting angle of the reflecting elements, the distribution within the area, structure types of the reflecting elements or by a combination thereof.

The scattering power towards the up and down direction increases by the tilting angle of the reflecting elements.

However, to maintain a wide viewing angle in the left and right direction it is necessary that the angles are limited within 0°<0<45° and −45°<φ<0° (clockwise rotation towards the 12h direction is notated as + and anti-clockwise rotation is notated as −, respectively).

Even if the principal structure of the reflecting element 14 of type-I is the same as to that of the reflecting element 24 of type-II so that both have the same individual principal scattering and reflection properties the impact of the scattering property of the screen is different due to their different orientation.

Of course, the principal structures of the reflecting elements 14 of type-I may also differ to that of the reflecting elements 24 of type-II.

In FIG. 9, a case of two types of reflecting elements are shown but there is no limitation and three or more types of reflecting elements may be utilized together. The relative positioning of the reflecting elements of type-I 14 and of type-II 24 is regular but the present invention is not limited to such a positioning.

Also continuous structures with a positive or negative relief structure as described in example-2 may be utilized.

Such a construction model is visualized schematically in FIG. 10.

Reflecting elements of type-I 14 and of type-II 24 are structured such that they are inclined towards the up and down axis.

The same types of linearly formed positive and negative relief structures as of example-2 may be utilized.

The reflecting elements of type-I and type-II may be oriented symmetrically or even asymmetrically towards the up and down axis.

The principal positive and negative relief structures of the type-I reflecting elements 14 may be same or differ to that of the type-II reflecting elements 24.

In any case, a mixture of types of reflecting elements that differ in their relative orientation of their maximal scattering direction relative to the left and right axis of the screen is utilized.

The overall effect of such a construction is based on the same principle as that shown in FIG. 9 so that a detailed description is omitted here.

In summary, a low cost screen that provides large viewing angles in the desired directions can be easily realized by the application of the above mentioned construction examples for the light-reflecting layer.

### COMMERCIAL APPLICABILITY

A front screen with an optimal wide viewing angle that is adapted to the viewing condition can be realized, in which the spatial viewing field can be controlled with the help of simple construction elements. Thus, this can be applied for image projection systems where it is necessary that a multiple of observers can view the image.

Realization of an image projection system that utilizes a front screen having a wide viewing angle in the desired direction is based on a simple construction.

The screen for an image projection system of the present invention is comprising a directional diffusing layer that has the property to diffuse and transmits incident light from a specific angular range and linearly transmits light from other direction, and a light-reflecting layer that is structured with reflecting elements that scatters and reflect light. The light-reflecting layer provides an anisotropic scattering property by means of reflecting elements that have different scattering fields toward the up and down direction versus the left and right direction. Thus, a construction that is optimized for the observation condition is given.

What is claimed is:

1. A projection system having a-screen for displaying an optical image and an image projector for projecting the optical image to the screen, comprising;
the screen including a directional diffusing layer and a light-reflecting layer,
wherein the directional diffusing layer transmits and diffuses incoming light from a specific angular range and linearly transmits incoming light from the other angular range, and
wherein the light-reflecting layer, which is disposed on the opposite side of the directional diffusing layer in regard of the displayed image, includes reflecting elements for scattering reflected light anisotropically, such that the scattering field of the reflecting elements differs in the left and right direction versus in the up and down direction.

2. A projection system according to claim 1, wherein the reflecting elements scatters the reflected light in a wider range in the left the right direction than in the up and down direction of the screen.

3. A projection, system according to claim 2, wherein the reflecting elements constitute of grooves on top of the reflecting layer, in which the flanks that form the grooves are oriented along the up and down direction.

4. A projection system according to claim 3, wherein the grooves are randomly positioned on the screen.

5. A projection system according to claim 3, wherein the flanks of the grooves are continuously shaped on the screen and oriented along to the up and down axis.

6. A projection system according to claim 5, wherein the grooves are aligned continuously in the left and right direction on the screen so that the cross-sectional profile in a plane in the left and right direction has a shape of a saw blade.

7. A projection system according to claim 2, wherein the reflecting elements constitute of protrusion on top of the light-reflecting layer, in which the flanks of the protrusion are continuously oriented long the up and down direction.

8. A projection system according to claim 7, wherein the protrusions are randomly positioned on the screen.

9. A projection system according to claim 7, wherein the protrusions are continuously shaped on the screen and oriented along to the up and down direction.

10. A projection system according to claim 2, wherein the reflecting elements have an elliptic shape, in which the larger diameter of the ellipses are oriented along the up and down direction on the screen.

11. A projection system according to claim 10, wherein the reflecting elements constitute of positive relief structures on top of the light-reflecting layer.

12. A projection system according to claim 10, wherein the reflecting elements constitute of negative relief structures on top of the light-reflecting layer.

13. A projection system according to claim 1, wherein the reflecting elements constitute of light-reflecting particles with an anisotropic shape, in which these light-reflecting particles are provided on top of the light-reflecting layer.

14. A projection system according to claim 13, wherein the light-reflecting particles have a rod-like shape or an elliptic and spherical shape.

15. A projection system according to claim 1, wherein the reflecting elements constitute of different types of reflecting elements with different anisotropic light-scattering properties.

16. A projection system according to claim 1, wherein two types of aforementioned reflecting elements are provided on top of the light-reflecting layer, in which the light-scattering properties of the two types of reflecting elements are different.

17. A projection system according to claim 16, wherein the two types of the reflecting elements are of same principal structure but differ in the orientation on the light-reflecting layer.

18. A screen for displaying an optical image, comprising;
a directional diffusing layer that transmits and diffuses incoming light from a specific angular range, and linearly transmits incoming light from the other angular range, and
a light-reflecting layer that is disposed on the opposite side of the directional diffusing layer in regard of the displayed image, and includes reflecting elements for scattering reflected light anisotropically, such that the scattering field of the reflecting elements differs in the left and right direction versus in the up and down direction.
